(19) United States
(12) Patent Application Publication
(10) Pub. No.: US 2021/0140467 A1
(43) Pub. Date: May 13, 2021

(54) Wall Hooks

(71) Applicant: Jan Einicke, Düsseldorf (DE)

(72) Inventor: Jan Einicke, Düsseldorf (DE)

(21) Appl. No.: 16/636,012

(22) PCT Filed: Aug. 7, 2018
(86) PCT No.: PCT/DE2018/100690

§ 371 Date: Feb. 2, 2020

(30) Foreign Application Priority Data
Aug. 8, 2017 (DE) 10 2017 117 977.1
Jul. 19, 2018 (DE) 20 2018 104 164.9

(51) Int. Cl. F16B 45/00; A47B 95/00; A47G 1/20

(52) U.S. Cl. CPC F16B 45/00; A47G 1/20; A47B 95/008

(57) ABSTRACT

The invention relates to wall hooks containing a) a U-profiled bracket (1), the b) U-profile limbs (2) of which are connected together by a U-profile base (3) and c) lie at a distance from one another, said distance being adapted to the diameter of the screw shaft of a securing screw, wherein the screw is to be used to secure the U-profiled bracket (1) to the wall, and d) a hook part which is arranged on the U-profiled bracket (1) and which e) is formed by at least one elbow that is located in the direction of the free ends of the U-profile limbs (2).

The invention concerns a wall hook.

Pictures as well as cabinet or shelf elements, depending on their size, are hung frequently with at least two nails, screws or wall hooks from a wall.

When these nails, screws or wall hooks are not fastened at the same height at the wall, an object hung therefrom hangs askew so that the fastening elements must be attached at new positions.

In the subsequently published DE 10 2016 109 043 A1 of the same applicant, a wall hook is described that comprise an elongated slot delimited by two sections that are located at a lateral spacing to each other. This wall hook has the shape of a U-profile whose U-profile legs form the two sections that are connected to each other by the base of the U-profile bracket. The hook part is arranged at the exterior side of the base and outside of the U-profile legs as an independent additional element.

In U.S. Pat. No. 4,641,807, US 2008/0105812 A1, and DE 30 00 299A1, wall hooks are described that have a wall part fastenable to a wall and provided with an elongate slot closed at both ends. The wall parts are generally fastened to a wall by means of fastening screws which are pushed through the slot. It is necessary to handle at the same time two elements, i.e., on the one hand, the wall part must be held and, on the other hand, the fastening screw must be pushed through the elongate slot and fastened to the wall at the same time. These known wall hook systems are relatively unwieldy and space-consuming so that they are expedient only for relatively large objects to be hung.

In DE 200 12 124 U1 a wall hook with a wall part that is fastenable at a wall in the conventional way and with a hook part that is arranged adjustably at the wall part in horizontal and vertical direction is described. For this wall hook, two fastening means are required, namely
a first fastening means for fastening the wall part to a wall, and
a second fastening means with which the hook part is adjustably fastened at the wall part.

This wall hook is relatively complex in regard to manufacture and to mounting.

DE 103 11 778 B3 describes a height-adjustable wall hook. This wall hook has a base member with a polygonal outer shape as a support surface for a picture frame or suspending elements or holders arranged at the picture frame. The base member is provided with an eccentric bore in such a way that the base member can be fastened to the wall in different rotational positions so that one of the support surfaces that have different spacings to the bore can be fastened at the wall in the position for hanging a picture frame, respectively. This known wall hook cannot be secured in a continuous fashion at different height positions and is also relatively space-consuming.

The wall hook described in DE 76 24 192 U has a U-profile bracket 1 which is not fastened immediately at a wall and fastened to the latter so as to point at a right angle away from the wall. For fastening this wall hook, L-profiles adjoin the legs of the U-profile 1 and are bent at a right angle thereto. The free legs of this L-profile are positioned parallel at a spacing relative to each other and delimit a slot extending in horizontal direction whose width is matched to the diameter of a fastening screw which can be screwed through this slot into a wall.

DE 75 37 192 U discloses a so-called peg wall hook for hooking in peg boards or peg walls and for hanging, for example, self-service packages. This peg wall hook as a U-profile bracket which in the mounted state extends horizontally and forwardly away from the peg wall. In these two hooks described last, project the sections forming the U-profile legs project at a right angle away from the wall.

U.S. Pat. No. 2,479,115 A discloses a wall hook which, as a main component, comprises a U-bracket. This U-bracket is fastened by means of a clamp to the wall.

The invention has the object to provide a wall hook which in regard to manufacture as well as mounting is simplified and thus improved.

As a solution to this object, a wall hook with the features of claim 1 is provided.

As the wall hook according to the subsequently published DE 10 2016 109 043 A1, a wall hook is provided that, as a result of the configuration as a U-profile bracket, comprises an open end so that the wall hook can be pushed onto a fastening screw that is fastened beforehand to the wall and, after pushing on the U-profile bracket, must only be tightened or screwed on fast. Compared to this wall hook, an additional element as a hook part arranged at the U-profile bracket is thus eliminated according to the invention.

The new wall hook is suitable in particular for hanging pictures that
are to rest with their backside against the wall and
for which the suspending element is to be covered entirely or at least as much as possible by the hung picture.

Preferred embodiments of the invention are disclosed in the dependent claims 2 to 13.

An advantage of the one-part wall hook according to the invention resides in that with it not only different heights of the fastening locations of adjacently arranged wall hooks in horizontal direction can be compensated but also a compensation in horizontal direction is possible in that the wall hook can be adjusted by pivoting prior to tightening of the fastening screw.

The invention will be explained in the following with reference to the drawing in more detail.

FIGS. 1a and 1b show a first embodiment of the wall hook according to the invention in a front view and in a side view;

FIG. 2 shows a modified embodiment of the wall hook according to the invention in side view;

FIGS. 3a, 3b, and 3c show in front view and in side view a further preferred modified embodiment of the wall hook according to the invention;

FIGS. 4 and 5 show front views of further modified embodiments of the wall hook according to the invention;

FIG. 6 is a comparison of the wall hook according to the invention relative to the wall hook according to DE 10 2016 109 043 A1.

According to FIGS. 1a to 3c, the wall hook according to the invention in its basic embodiment is comprised of circular round or rectangular wire which is bent to a U-profile bracket.

The U-profile bracket has two U-profile legs 2 as well as an arc-shaped U-profile base 3 connecting the two U-profile legs 2.

According to FIG. 1b, a bent section 3′ forming a hook part is provided in direction of the free ends of the U-profile leg 2. The bent section 3′ is positioned at an angle of the magnitude of 145° relative to the two U-profile legs 2 according to FIG. 1b.

In the embodiment according to FIG. 2, the bent section 3′ has additionally an angled portion.

While according to FIGS. 1a, 1b, and 2, the U-profile bracket is fastened with its open slot end pointing downwardly at the wall, the modified U-profile bracket illustrated in FIGS. 3a, 3b, 3c is fastened at a wall with its open slot end pointing upwardly.

According to FIGS. 3a, 3b, and 3c, the U-profile bracket 1 has two U-profile legs 2 of different lengths. The end of the longer U-profile leg 2 is provided with a bent section 2′.

The wall hook is comprised of an elastically deformable wire. The two U-profile legs are curved across their length and are therefore under pretension after fastening of the wall hook by means of a screw 4 so that the fastening force of the wall hook at a wall is increased.

With the wall hook according to the invention, height and lateral deviations for incorrect original attachments at the wall can be corrected/compensated by height displacement and lateral pivoting after releasing the screw 4.

According to FIG. 4, the wall hook 1, for pounding in a nail 5a, has an additional eye 5 which is preferably arranged as a securing element at the free end of one of the two legs in case that the screw 4 is tightened only insufficiently.

This eye 5 according to FIG. 4 can be replaced by a loop 5a arranged at the free end of one of the legs 2 for pounding in a nail 6 so that, in case of need, the wall hook 1 can be removed without having to remove the nail 6.

In FIG. 6, the difference between the wall hook according to the subsequently published DE 10 2016 109 043 A1 and the subject matter of the invention is illustrated. According to DE 10 2016 109 043 A1, the hook part 2 is arranged outside of the base and the U-profile legs 2 of the U profile, as illustrated by the bending line a. In contrast thereto, in the wall hook according to the invention the bending line c for forming the hook part 3′ is in the region of the U-profile legs 2.

What is claimed is:

1.-13. (canceled)

14. A wall hook comprising
a U-profile bracket bent from a wire;
the U-profile bracket comprising U-profile legs positioned at a spacing from each other and each comprising a first end and a second end opposite the first end, wherein a spacing between the U-profile legs is matched to a diameter of a screw shaft of a fastening screw with which the U-profile bracket is to be connected to a wall;
the U-profile bracket comprising a U-profile base connecting the first ends of the U-profile legs to each other, wherein the second ends of the U-profile legs leave open an opening between them;
the U-profile bracket comprising a hook part formed by at least one bent section of at least one of the U-profile legs.

15. The wall hook according to claim 14, wherein the at least one bent section is arranged at the U-profile base.

16. The wall hook according to claim 14, wherein the at least one bent section is arranged at the second end of the at least one of the U-profile legs.

17. The wall hook according to claim 14, wherein the wire has a circular cross section.

18. The wall hook according to claim 14, wherein the wire has a rectangular cross section.

19. The wall hook according to claim 14, wherein a first one of the U-profile legs is longer than a second one of the U-profile legs.

20. The wall hook according to claim 19, wherein the at least one bent section is arranged at the second end of said first U-profile leg that is longer.

21. The wall hook according to claim 14, wherein the at least one bent section is positioned at an angle of 145° relative to the at least one of the U-profile legs.

22. The wall hook according to claim 14, wherein the at least one bent section comprises an angled portion.

23. The wall hook according to claim 14, wherein the wire is elastically deformable such that the U-profile legs are curved across a length thereof so as to be under pretension when the U-shaped bracket is connected to a wall.

24. The wall hook according to claim 14, further comprising a securing element arranged at the second end of one of the U-profile legs.

25. The wall hook according to claim 24, wherein the securing element is an eye or a loop.
